(19) United States
(12) Patent Application Publication
(10) Pub. No.: US 2012/0192432 A1
(43) Pub. Date: Aug. 2, 2012

(54) Flexible Razor Assembly

(76) Inventor: Wallace Zane, Venice, CA (US)

(21) Appl. No.: 13/019,293

(22) Filed: Feb. 1, 2011

(51) Int. Cl. B26B 21/02; B26B 21/56

(52) U.S. Cl. 30/50; 30/346.5

(57) ABSTRACT

A shaving implement, the form of which is a system of interlinked circular razors having the appearance of a metallic cloth, held together by fabric or metal thread. The flexible shaver is meant to replace razors of the wet shave type, providing greater safety in shaving the skin, and in cleanliness of the shaver itself The cutting areas of the circular razors are each slightly larger than an average hair, greatly reducing the chance of cutting oneself The shaver conforms to the contours of the skin, and increases the efficiency of shaving compared to current depilatory shavers.

### CROSS-REFERENCE TO RELATED APPLICATIONS

Not Applicable

### STATEMENT REGARDING FEDERALLY SPONDORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

The field of the invention is depilatory shavers, namely safety razors and electric shavers.

Usually, manual razors are made of one or more thin metal blades sharpened on one side or both sides, and affixed to a rigid handle. These blades are limited in their flexibility, despite attempts to address this problem (for example, U.S. Pat. Nos. 7,739,797; 6,430,814). Each of these are unsatisfactory, either due to the chance to cut one's skin as one presses the blade into the skin in the attempt to get a close shave, or in limitations on the flexibility of the cutting surface.

Electric shavers usually require a shield between the skin and a rapidly rotating set of metal blades, which has the effect of lessening closeness of the shave (for example, U.S. Pat. Nos. 6,901,662; 6,584,691). Partly, this lack of closeness is due to the need for safety.

A shaver that completely conforms to the contours of the skin is needed. Such a shaver has been proposed (U.S. Pat. No. 5,802,720). However, that shaver lacks efficiency in cutting and is complex to manufacture.

The present invention increases safety and efficiency in shaving, ease of cleaning the shaver, as well as ease of manufacture compared to previous disclosures.

### BRIEF SUMMARY OF THE INVENTION

It is an object of the present invention to provide a shaving implement that meets the requirements of closeness in shaving, safety, ease in cleaning, and ease of manufacture.

The present invention meets this object by using an interlocking system of circular razors that have the appearance of a cloth. The aperture of each razor is slightly larger than the size of a human hair, only allowing one hair to enter the razor at a time and preventing skin from entering and being cut along with the hair. Each razor is composed of a single piece of metal consisting of the circular razor opening and four wings which are folded upwards and have eyelets provided to thread the razors together. In the center of the metal piece is a circular hole with thickness of the metal tapering towards the center of the hole which serves as the cutting edge of the razor. The width of each razor with wings folded upwards should be between 2 mm and 6 mm, allowing for cloth-like flexibility when threaded together with fabric or metal thread. The threads and the structure of the razors allow the razor assembly to hold water and shaving cream as a lubricant. The preferred embodiment of the razor assembly will be the size of a small washcloth, 15 cm by 15 cm, or larger, all of which is potentially cutting area and conforms to the contours of the skin, as a washcloth would. The user can apply as much of the cutting area as is wished, which can greatly reduce the time required to shave, especially on larger areas, such as legs.

### BRIEF DESCRIPTION OF THE SEVERAL VIEWS OF THE DRAWING

FIG. 1 is a side elevation view of the razor.

FIG. 2 is a top plan view of the razor.

FIG. 3 is a bottom plan view of the razor.

FIG. 4 is a portion of a cross sectional view taken along line III-III of FIG. 1.

FIG. 5 is a perspective view showing the underside of the razor.

FIG. 6 is a view of the portion of the razor assembly, showing threads.

FIG. 7 is a perspective view of the razor assembly, without detail, showing that the razor assembly can conform to different contours at once.

### DETAILED DESCRIPTION OF THE INVENTION

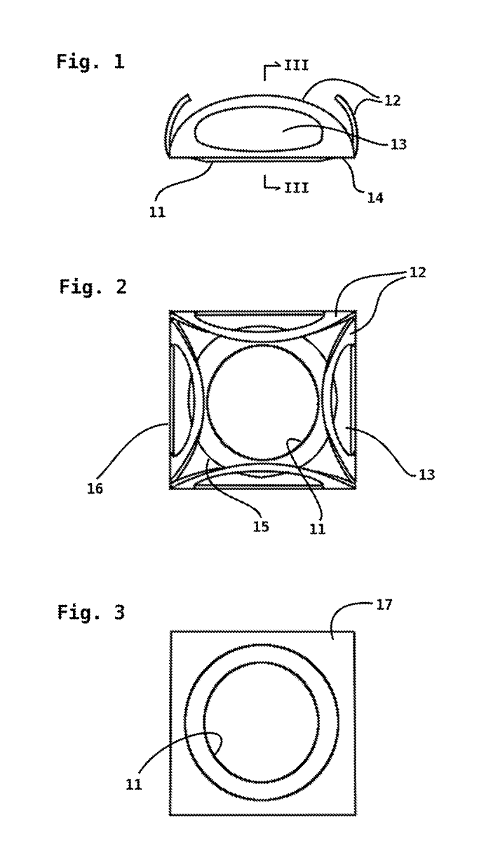

A razor of the present invention is shown in side plan view in FIG. 1. The razor has a cutting edge 11, and wings 12 for assembly with thread through the threading holes 13. In the preferred embodiment, the wings 12 are bent upwards and slightly towards the center of the razor in a curved fashion to allow a wide range of flexibility between the razors in the assembly. The cutting edge 11 extends slightly below the primary bottom of the razor 14.

In top plan, in FIG. 2, the wings 12 of the razor can be seen bent slightly towards the center. One can also see the threading holes 13 positioned in such a way as to allow passage of threads in holding together the assembly. The cutting edge 11, begins to taper 15 from the thickness of the main element of the razor half the distance from the edge of the razor 16 to the cutting edge 11.

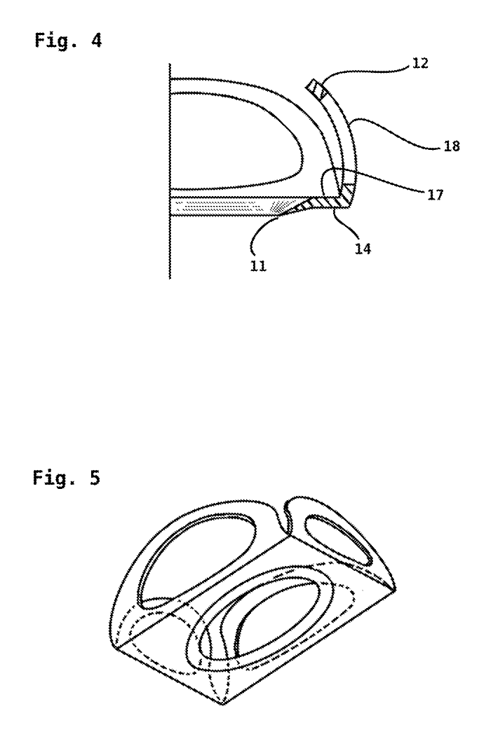

In bottom plan, in FIG. 3, one can see that the primary bottom 14 of the razor is flat, except for the slight extension of the cutting edge 11.

In cross-section, as seen in FIG. 4., the cutting edge is tapered at an angle of 30 degrees from the top of the primary bottom 17 of the razor and of 15 degrees from the bottom of the primary bottom 14. Other angles may be desired as well as varying depths of the taper to the cutting edge or extensions of the cutting edge from the primary bottom, depending on the toughness of the material to be cut.

When the wings are folded upwards from the primary bottom of the razor, the razor will have the appearance of a small box that can be aligned easily with other razors to make the assembly, as can be seen in FIG. 5.

The inward curve 18 of the wing of the razor, as seen in FIG. 4 and in FIG. 1 allows for the razor to rotate in a wide angle against the curved wings of adjacent razors in the flexible razor assembly.

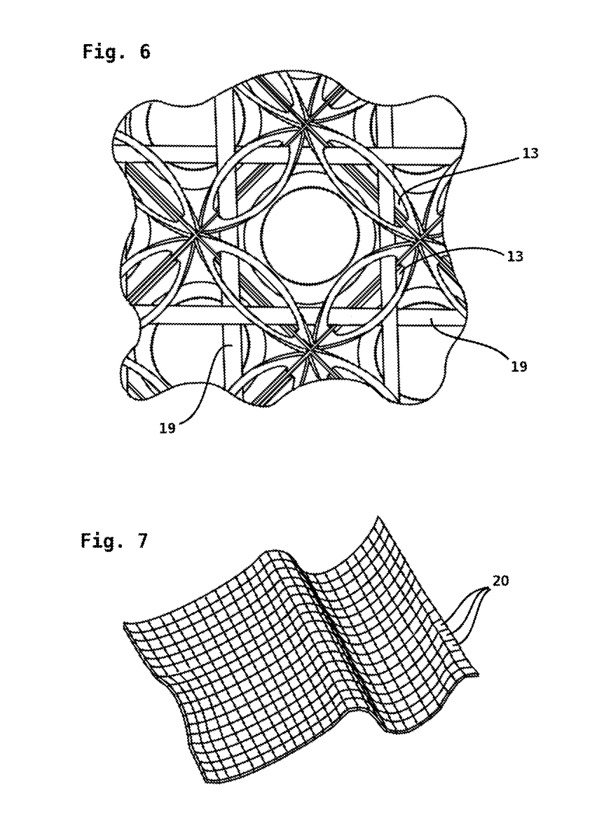

The razors are intended to be threaded in an assembly. FIG. 6 shows a close view of a portion of a threaded razor assembly in top plan. The threads 19 pass through the threading holes 13. Best results will be obtained if the threads are aligned at an angle to the corners of each razor, keeping the aperture of the razor relatively open. This openness decreases the possibility that debris such as hair and soap residue will accumulate, and, further, increases the ease of cleaning.

For cleaning purposes, the razor assembly may be treated like a washcloth, and washed by hand or in a washing machine.

The method of use is intended to be very similar to a washcloth as the razor assembly is intended to have a cloth-like flexibility. FIG. 7 shows the razor assembly without detail to indicate that the razors 20 can conform to any contour, with allowances made for the width of each razor, but limited otherwise only by the slack or resiliency of the thread used to hold the assembly together. The user will hold the razor assembly with the cutting edges against the skin and rub in any direction to cut off unwanted hairs.

The preferred embodiment is composed of razors with an aperture of the cutting edge slightly less than 2 mm. The razor assembly of the preferred embodiment is 15 cm square, although any desired size is conceivable.

While the razor assembly so described is that of an implement to shave unwanted hair, similar embodiments could be made in the form of tools used in other fields. Larger apertures on the razors and deeper extensions of the cutting edges could allow for wood to be abraded in the manner of a rasp, which could be useful for working curved or contoured wood. Similarly, with small adjustments to the various features of the razors, vegetable peelers, or graters, could be formed for kitchen use.

What is claimed:

1. A shaving implement consisting of an assembly of small circular razors.

2. Each razor is composed of
a) a cutting edge, slightly larger than a human hair, that projects downward from an otherwise flat bottom,
b) wings with eyelets that allow thread to be strung and form connections between the razors,
c) with the entirety of the razor formed from a single piece of metal.

3. Said wings, when folded, form right angles to each other, giving straight sides to each razor for
a) ease of manufacturing the assembly, either by hand or machine,
b) and allow the assembly to conform to the contours of the skin.
